(19) United States
(12) Patent Application Publication
(10) Pub. No.: US 2025/0316019 A1
(43) Pub. Date: Oct. 9, 2025

(54) REDUCING BANDWIDTH USAGE AND ADJUSTING VIEWING EXPERIENCES OF AUDIOVISUAL STREAMS IN VIRTUAL ENVIRONMENTS

(71) Applicant: Shaffra Holdings Ltd, Dubai (AE)

(72) Inventors: Marc Wehbi, Beirut (LB); Andreas Mohr, Rösrath (DE); Tuomas Lauttia, TAMPERE (FI)

(21) Appl. No.: 18/630,829

(22) Filed: Apr. 9, 2024

(51) Int. Cl. G06T 17/00; H04N 7/01; H04N 13/279

(52) U.S. Cl. CPC G06T 17/00; H04N 7/0117; H04N 13/279

(57) ABSTRACT

The technology described herein is directed towards optimizing video streams in three-dimensional (3D) virtual environments. The technology intelligently manages bandwidth, including by halting the download of video streams that are out-of-view of a viewport of a user's camera viewing a 3D virtual environment, which conserves resources and their associated costs. Further, the technology can dynamically adjust the resolution of the video stream based on the viewing proximity of display screens that are within the camera viewport and rendered in the 3D virtual environment, balancing video quality with reduced bandwidth for video streams presented on display screens that the viewer perceives as more distant. The audio data and video data of audiovisual content are separated, whereby the audio stream can continue uninterrupted regardless of whether, based on a user's camera view within a 3D space, the video stream is selectively downloaded for rendering, or is not downloaded.

### BACKGROUND

The rendering of streamed video content within a three-dimensional (3D) environment presents challenges that result from the distinctive nature of 3D graphics and the intricacies of video streaming. As one example, unlike conventional two-dimensional video rendering, integrating streamed video into a 3D environment is highly resource intensive.

### BRIEF DESCRIPTION OF THE DRAWINGS

The technology described herein is illustrated by way of example and not limited in the accompanying figures in which like reference numerals indicate similar elements and in which:

FIG. 1 is a block diagram showing an example system for communicating audiovisual data in a way that can reduce bandwidth and improve viewing experiences, in accordance with various embodiments and implementations of the subject disclosure.

FIGS. 2-6 are representations of example scenarios with respect to selective stream management, including video resolution management, in accordance with various embodiments and implementations of the subject disclosure.

FIGS. 7-9 comprise a flow diagram of example operations related to selective stream management logic, in accordance with various embodiments and implementations of the subject disclosure.

FIG. 10 is a flow diagram showing example operations related to taking action to halt downloading of video stream data based on detecting that its display screen is not within a viewport of a camera that is viewing part of a 3D virtual environment, in accordance with various embodiments and implementations of the subject disclosure.

FIG. 11 is a flow diagram showing example operations related to streaming a video component at different resolutions as requested by a client device, in accordance with various embodiments and implementations of the subject disclosure.

FIG. 12 is a flow diagram showing example operations related to rendering a video stream on a video display screen at different resolutions based on perceived proximity, and requesting downloading of the video stream be halted based on detecting that the display screen is no longer within a camera's viewport, in accordance with various embodiments and implementations of the subject disclosure.

FIG. 13 is a block diagram representing an example computing environment into which embodiments of the subject matter described herein may be incorporated.

FIG. 14 depicts an example schematic block diagram of a computing environment with which the disclosed subject matter can interact/be implemented at least in part, in accordance with various embodiments and implementations of the subject disclosure.

### DETAILED DESCRIPTION

Various aspects of the technology described herein are generally directed towards improving (better optimizing) video streams for rendering in three-dimensional (3D) virtual environments. In one aspect, the technology described herein intelligently manages bandwidth via selective stream management, which operates to selectively render or pause the rendering of video streams based on their alignment with the user's camera view. This results in more efficient resource utilization within the dynamic 3D space, by halting the download of out-of-view video streams (with respect to a camera's viewport), thereby conserving resources (e.g., network bandwidth) and associated costs. In another aspect, selective stream management also dynamically adjusts the resolution of respective video streams based on the viewer's proximity to their respective displays within the viewport, to provide a balance between visual quality and bandwidth efficiency within an immersive 3D space.

In one aspect, unlike traditional streaming approaches, the technology described herein strategically separates audio and video data. As a result, while the video stream is selectively rendered or not based on the user's camera view within the 3D space, the audio stream continues uninterrupted, ensuring a coherent auditory experience. This aligns seamlessly with the dynamic nature of web-based, graphics processing unit-rendered 3D environments, for example, including by enhancing user engagement and efficient use of resources. By decoupling audio and video data, the technology described herein addresses the aspects of immersive 3D environments, including by allowing users to hear the audio component associated with a video stream irrespective of the video stream's rendering status. This enhances adaptability to the dynamic nature of WebGPU-rendered 3D spaces, providing users with a coherent and engaging audiovisual experience.

In one implementation, the technology described herein facilitates rendering in full 3D environments, such as when using WebGPU (a graphics and compute API designed for the web platform and modern browsers, providing low-level access to the GPU for enhanced performance in rendering complex graphics, such as those found in 3D virtual environments). By strategically managing bandwidth, including by selectively halting out-of-view streams and dynamically adjusting resolution of displayed video streams, the technology provides web-based, immersive content delivery via a refined and efficient approach to delivering audiovisual content in the dynamic area of 3D virtual environments.

It should be noted that terms used herein, such as “optimize,” “optimized,” “optimization,” “optimal,” “optimally” and the like only represent objectives to move towards a more optimal state, rather than necessarily obtaining ideal results. For example, “optimal” resolution of a video screen means selecting a more optimal resolution over another option, rather than necessarily achieving an optimal result. Similarly, “optimizing” bandwidth means conserving bandwidth to the extent possible, within the constraints of providing a desirable user experience.

It also should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in computer graphics, online communication, and/or immersive web experiences in general, where users may seek interactive and immersive experiences beyond traditional two-dimensional interfaces. For example, much of the description and examples herein are directed to the optimization of audiovisual streams within dynamic three-dimensional (3D) virtual environments, including by employing techniques tailored for real-time rendering and interaction, such as by incorporating WebGPU, a modern Web Graphics API that enables sophisticated rendering capabilities directly within web browsers. Notwithstanding, the technology is not limited to WebGPU, browsers, nor immersive 3D experiences, but provides benefits in computing and audiovisual communication in general via a better optimization of video streams in 3D virtual environments.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

The following detailed description is merely illustrative and is not intended to limit embodiments and/or application or uses of embodiments. Furthermore, there is no intention to be bound by any expressed or implied information presented in the preceding sections, or in the Detailed Description section.

It should be noted that streaming video content with desirable quality to a large user base has significant financially-related challenges due to substantial bandwidth requirements and infrastructure costs. Note further that rendering streamed video in a 3D environment introduces complexities beyond the conventional playback of preloaded videos, whereby traditional methods of video streaming on websites do not align with the complexities of rendering full 3D environments. For example, traditional methods bundle both audio and video data in a single stream, assuming simultaneous rendering and playback. However, with streamed video viewed in a 3D environment, the video content needs to be dynamically integrated into a real-time, interactive 3D space, thereby needing advanced rendering techniques to ensure seamless integration with the immersive environment. The dynamic nature of 3D scenes adds further complexity, making efficient resource management highly desirable for more optimal performance.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

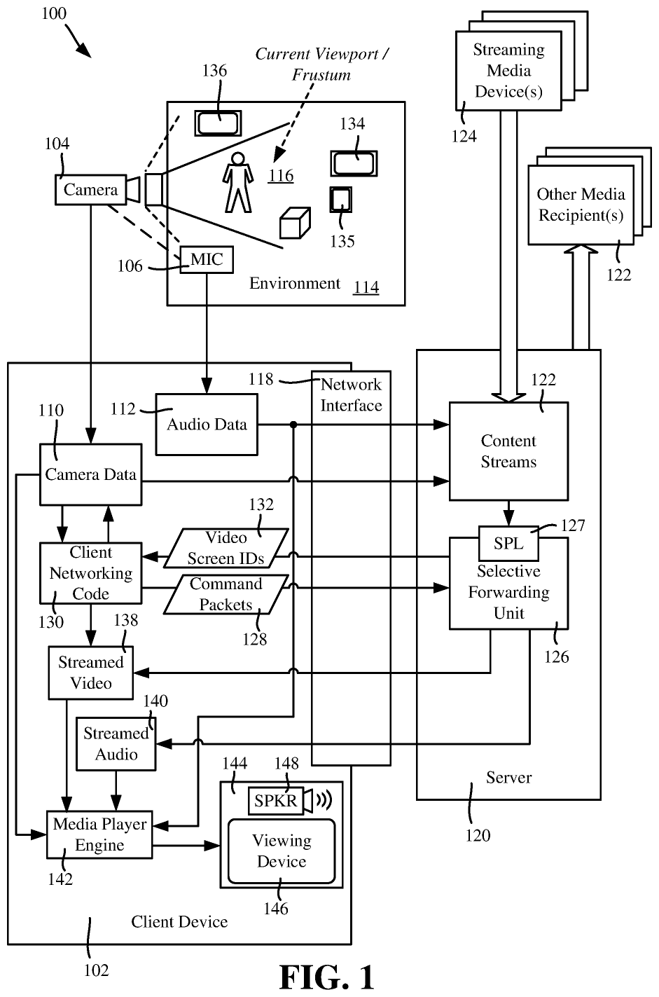

FIG. 1 shows a generalized block diagram of an example system 100 including a client device 102 that is coupled to (or incorporates) a camera 104 and a microphone 106. The camera and/or microphone can be peripheral accessories, and the camera 104 and microphone 106 may be combined within a single unit and interfaced to or built into the client device 102. In general, the camera 104 captures video data 110 and the microphone captures audio data 112 sensed within a 3D virtual environment 114. The camera also may be physically coupled to an actual or virtual user, or otherwise controlled thereby, and thus “move about” in the 3D environment 114, changing the distance to objects, the zoom amount and/or the panning angle accordingly. In any event, depending on current camera position, zoom and/or pan angle, the camera has a current viewport (or frustum) 116, which refers to the visible area within the user interface of a 3D virtual environment 114. That is, the viewport 116 represents the portion of the 3D environment 114, which is basically shaped like a pyramid, that is currently being displayed on a user's viewing device.

The video data 110 and the audio data 112 can be streamed via a network interface 118 or the like to a server 120 (e.g., running in the cloud) for possible distribution to one or more other media recipients 122, and possibly for recording. At the same time, the server 120 may be obtaining content (audiovisual) streams 122 from one or more other streaming media devices 124, which encompasses both audio and video components of a stream; the server 120 performs unified and coherent management of both auditory and visual aspects within the 3D virtual environment 114.

In general, the server 120, via a selective forwarding unit 126 as described herein, sends content back to the client device 102 (and possibly the one or more other media recipients 122) for rendering streaming output. More particularly and as will be understood, the server 120 splits combined audiovisual content into separate audio and video content. To this end, the selective forwarding unit 126 of the server 120 can incorporate or be coupled to a splitting component (SPL) 127 to perform the separation of the audiovisual content into the video and audio components. The video component(s) are for displaying on video display screen(s) that are present in the virtual environment 114, and, as will be understood, those video display screen(s) currently in the viewport 116.

The selective forwarding unit 126 of the server 120 is responsive to requests (command packets 128) from client networking code (logic) 130 of the client device 102 to send only the content stream of each video screen, based on an identifier (ID) 132 of that video screen and its associated video stream, that is within the current camera viewport 116. Further, the networking code 130 sends other command packets 128 to control the video resolution of the video appearing on each video screen that is within the current camera viewport 116, based on true pixel size, which can be determined from the camera's (and thus the viewer's) perceived proximity to each display (video) screen that is displaying a video stream.

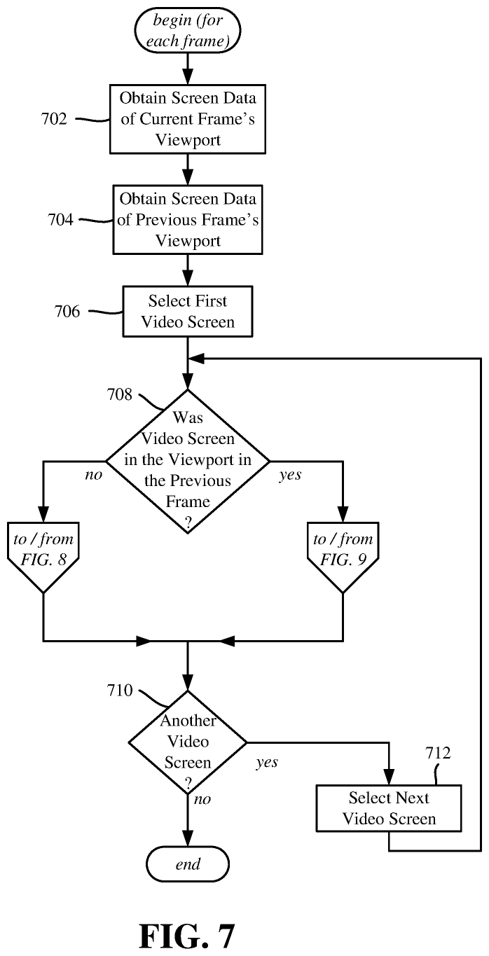

More particularly, the client networking code 130 processes the captured camera data 110 to determine which video screens, if any, are in the camera viewport 116 for the current frame, as well as which video screens were in the camera viewport for the previous frame. The client networking code 130 instructs the server 120 not to stream video for video screens that are not in the current frame. For each video screen that is in the current frame, the client networking code 130 determines what the resolution for that video screen should be based on true pixel size detected by the processing of the client networking code 130, and instructs the server 120 if any change to the resolution is needed. Details of the client networking code's processing logic are described with reference to FIGS. 7-9.

Thus, for example, in FIG. 1 the video/display screen 134 and the video/display screen 135 that are within the camera viewport 116 have their respective video components streamed from the selective forwarding unit 126, whereas the video screen 136 that is not within the camera viewport 116 does not have its video streamed to the client device 102. However, the audio associated with each of the videos for the screens 134, 135 and 136 continues to be streamed independent of whether the video is streamed.

Further, based on the perceived proximity, corresponding to the true pixel size of a display screen, which depends on the current zoom level and distance from the camera 104 to a display screen, e.g., the video screen 134, possibly along with the size of the video screen 134, the client networking code 130 selects the resolution (e.g., low, medium or high) at which the video for that video screen 134 is to be downloaded, and similarly does so for the video screen 135. To reiterate, the audio is sent regardless of whether a video screen is visible. Note that while low, medium or high resolutions are described in the examples herein, the technology is not limited to these three resolutions; for example, there may be more than three resolutions available for selection.

As such, the streamed video 138 is viewed on corresponding rendered display screen(s) in the rendered viewport portion of the environment 114, whereby the user views a combination of the camera-captured stream data 110 and any streamed video 138 downloaded from the selective forwarding unit 126. Whether a display presents video depends on whether its video display screen is in the current viewport 116, and significantly, its video is not downloaded if the video will not be displayed. The client audio data 140 is typically some combination of the microphone-captured audio data 112 and the streamed audio 140 downloaded from the selective forwarding unit 126, regardless of whether a video screen corresponding to that audio is in the current viewport 116 or not.

The captured camera data video and any streamed video component(s) are rendered by a media player engine 142 in an immersive 3D environment from the perspective of a client viewer. For example, the media player engine 142 may be based on the WebGPU API that renders to a browser, or other 3D rendering technology. In any event, the media player engine 142 outputs to one or more media output devices 144, which in FIG. 1 includes a viewing device 146 such as a display monitor, 3D headset or the like, and an audio output device such as a speaker set 148 (e.g., speaker system, headphones, earphones, integrated 3D headset speakers or the like) coupled to or incorporated into the client device 102.

Thus, by decoupling the streamed video data 138 from the streamed audio data 140, the technology described herein addresses certain considerations with respect to immersive 3D environments, allowing users to hear the audio component of a video stream, irrespective of that video stream's rendering status. Separating the video and audio facilitates adapting to the dynamic nature of (e.g., WebGPU) rendered 3D spaces, providing users with a coherent and engaging audiovisual experience.

As can be seen, the media player engine 142 renders audiovisual media streams (such as webcams or other video) as textures. Because these textures cannot be preloaded and have an overhead cost (particular bandwidth), the technology described herein operates to optimize both the frame time and bandwidth. Note that known other approaches do not provide the streaming server with information as whether or not an object is within the frustum of the user, nor do these other approaches usually split the audio and video into separate tracks in order to achieve such a level of control as described herein.

In contrast to other approaches, the immersive nature of 3D environment 114 described herein needs to react with dynamic rendering based on the user's interactions with the 3D environment 114. As such, when the technology described herein obtains an audiovisual stream at the server 120, the server 120 (e.g., the selective forwarding unit 126 and SPL 127) splits the audiovisual stream into audio and video, and is thereby able to send them as separate streams to the client device 102. This separating of audio and video tracks from a stream allows the video stream to be associated with the frustum of the user.

As described herein the client device 102 may or may not want certain video stream content depending on whether any media stream objects, comprising video display screens such as monitors, televisions, canvas or screens in general, are within the frustum or not. When a stream leaves the frustum, the client device 102 detects this and automatically notifies the server 120 so as to stop receiving data for the video media stream, whereby the client will stop rendering the video, thus saving both frame time and bandwidth. Regardless of whether the video stream is selectively rendered or halted based on the user's camera view within the 3D space, the audio stream continues to be transmitted and played through the selective forwarding unit 126 on the server 120 to ensure a seamless auditory experience even when the audio's associated video is not being actively displayed. Additionally, bandwidth is further optimized by determining the perceived distance between the camera and the video screen and adjusting (upscaling or downscaling) the resolution accordingly, as lower resolution videos cost less bandwidth than higher resolution videos.

To summarize, aspects of the technology described herein are directed to halting downloads from the server 120 for video screens that are out of the camera's viewport 116. The client networking code 130 dynamically manages the download of video streams within the 3D virtual environment 114, unlike traditional streaming methods that stream continuous video data transmission regardless of whether the video content is within the user's field of view. To this end, the client networking code 130 monitors the user's camera view within the 3D space 114, and when a video screen display is not detected within the user's viewport, the client networking code 130 acts to selectively halt the download of the corresponding video stream from the server 120. This conserves valuable bandwidth resources, as well as works to optimize overall system performance. Significantly, while the video stream is paused, the audio component 140 of the stream continues to be transmitted and played through the selective forwarding unit 126 on the server 120, which ensures a continuous and seamless auditory experience for the user, even when the associated video content is not actively being rendered.

Another aspect of the technology described herein is directed to dynamically changing streamed video resolution based on a video screen's perceived distance to the camera 104, that is, dynamic resolution adjustment is performed based on the perceived proximity of the video screen to the user's camera view. This is in contrast to traditional streaming approaches that rely on fixed resolutions, which can result in suboptimal visual quality and/or unnecessary bandwidth usage. To this end, the technology described herein dynamically adapts the resolution of each video stream as appropriate, such as based on the distance between the viewer (via the camera 104) and the display screen within the 3D space 114. For example, as a user physically or virtually coupled to the camera 104 approaches or moves away from a video screen display, the distance to that display changes; if the resolution is no longer appropriate for the new distance, the client networking code 130 communicates with the selective forwarding unit 126 of the server 120 to intelligently adjust the resolution in real-time. This ensures that users experience more optimal visual quality, with higher resolutions when close to a display, and lower resolutions when at a distance. By tailoring the resolution to the viewer's perceived proximity, the algorithm strikes a balance between visual fidelity and bandwidth efficiency. Such resolution adjustment contributes significantly to the overall optimization of video streams within 3D virtual environments, providing users with an immersive and visually pleasing experience while more efficiently managing bandwidth resources.

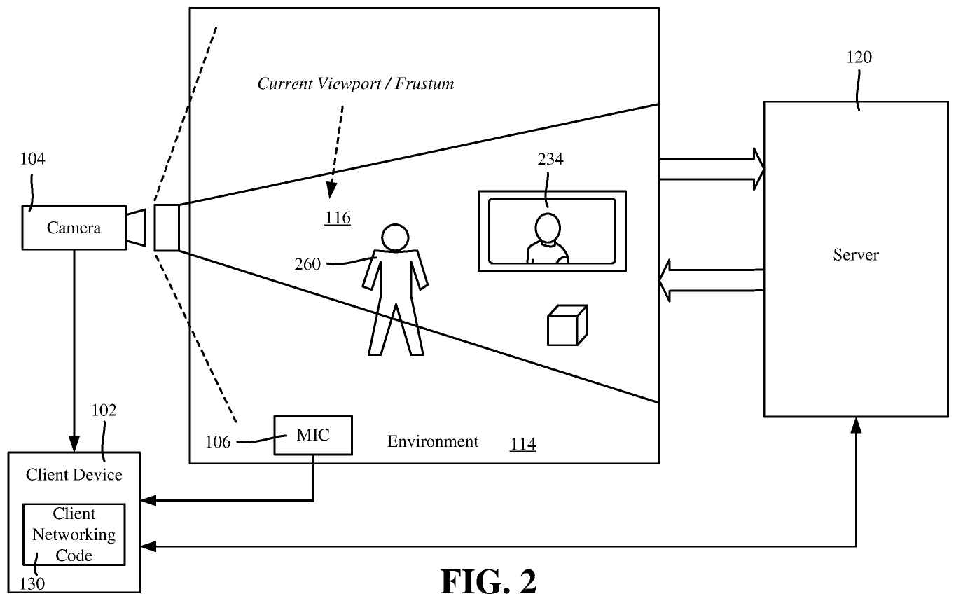

FIGS. 2-6 are representations of example scenarios with respect to whether to render a video screen in the client's 3D video output as texture data, and if so, at what resolution the client device 102 is to receive the video screen data from the server 120. Note that labeled components in FIGS. 2-6 generally correspond to the labeled components in FIG. 1, except to note that the current viewport 116 includes a labeled player component/digital twin 260, and that the video screen is labeled 234, 334, 434 and 534 in FIGS. 2-6, respectively, because the video screen is perceived as different in size, and possibly type, and/or is in a different position.

Thus, in the example of FIG. 2, the camera 104 has a current viewport 116 that senses an environment 114 which includes a video screen 234. The client networking code 130 detects the video screen 234 within the current viewport 116, and if the video screen 234 was not within the viewport 116 in the previous frame, (if previously within the viewport the video screen's video data already would be being streamed), requests that the video begin being streamed by the server 120 for the video screen 234; the request can be part of a request for a particular, distance-based selected resolution. As such, in the example scenario of FIG. 2, the server sends both audio and video corresponding to the video screen and its associated audio, and the client device renders the video as texture data.

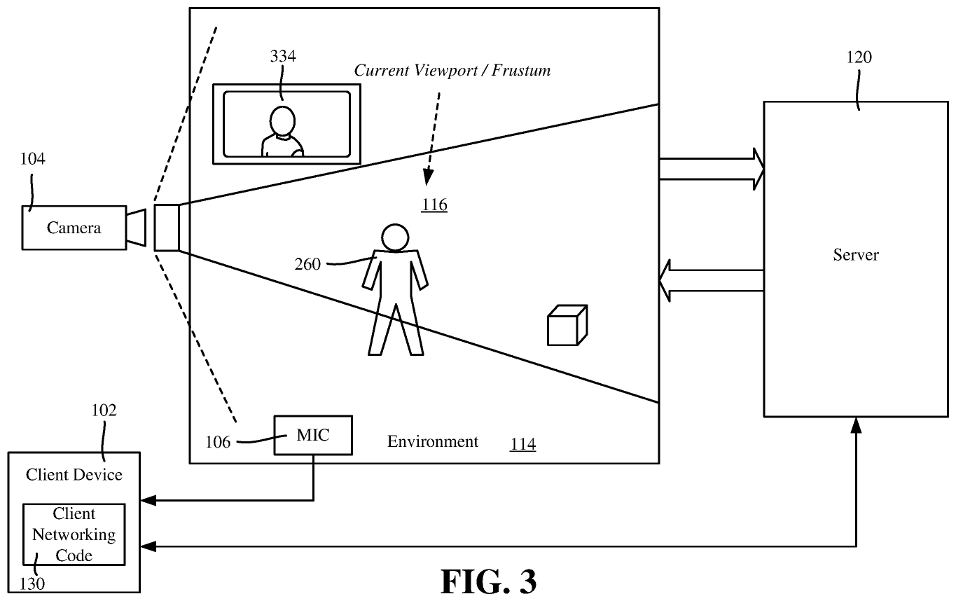

In contrast, in the example of FIG. 3, the video screen 334 is not within the current viewport 116 of the camera 104, which the client network code 130 (FIG. 1) detects. If the video screen 334 was in the viewport for the previous frame, the video for that screen will still be being downloaded, so to halt the downloading, the client networking code 130 (FIG. 1) instructs the server 120 to stop sending the video for the video screen 334. As such, in the example scenario of FIG. 2, the server 120 sends only the audio associated with the video screen 334 for client device output; (in the example of FIG. 2, there are no other video display screens within the viewport 116).

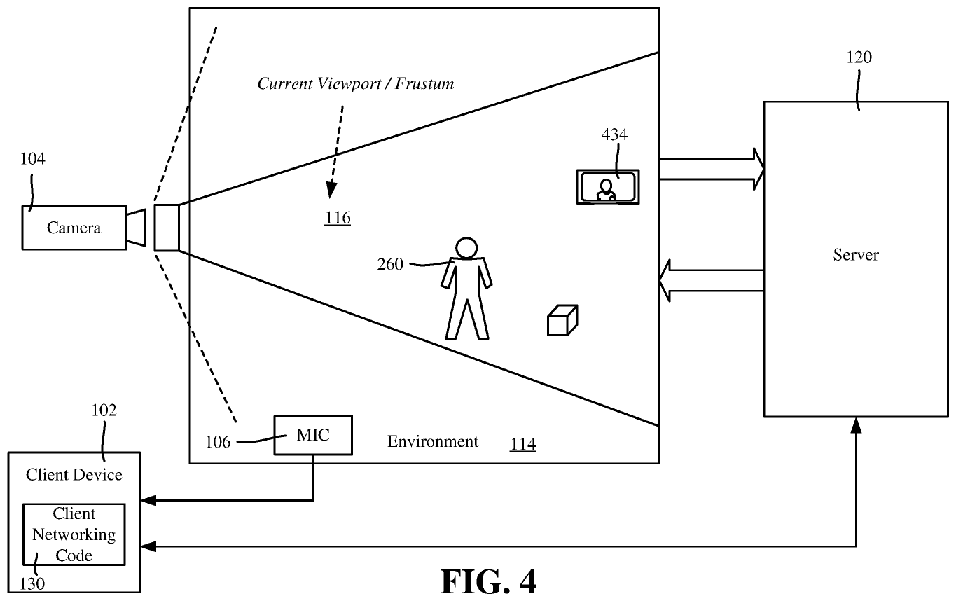

Turning to video resolution-related requests, in the example scenario of FIG. 4, the camera 104 has a current viewport 116 of the environment 114 that includes a video screen 434. The client networking code 130 detects the video screen 434 within the current viewport 116, and in this example determines that the true pixel size of the video screen 434 is small, such as based on distance from the camera 104, the camera 104 being zoomed out, and/or the corresponding size/type of the screen (e.g., a 6-inch smartphone screen versus a 20-inch monitor versus an 85-inch display). This small size corresponds to low resolution, and if the streamed video for the video screen 434 is not already being streamed at low resolution (which the client networking code 130 tracks), the client requests that the video be streamed by the server 120 at low resolution. Note that if the video screen was not within viewport 116 in the previous rendering frame, the low resolution request also starts/resumes the video streaming. Thus, in the example scenario of FIG. 4, the server 120 downloads a low resolution version of the video. Note that if low resolution video was already being sent for the video screen 434, the client networking code 130 need not change the resolution, however if not previously being sent at all, and/or not previously being as the low resolution version, the client networking code 130 requests that the resolution be downloaded as low resolution.

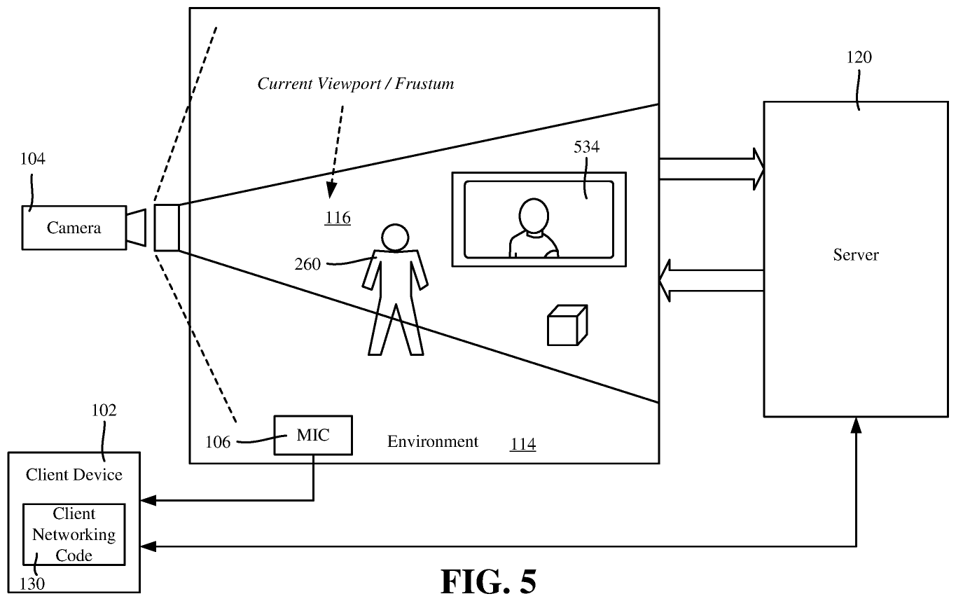

In the example scenario of FIG. 5, the camera 104 has a current viewport 116 that includes a video screen 534. In this scenario, the client networking code 130 determines that a medium resolution version is appropriate, e.g., the screen is at a medium distance. As before, the client networking code 130 requests the video screen 534 have its video streamed at medium resolution (if not already being streamed at the medium resolution).

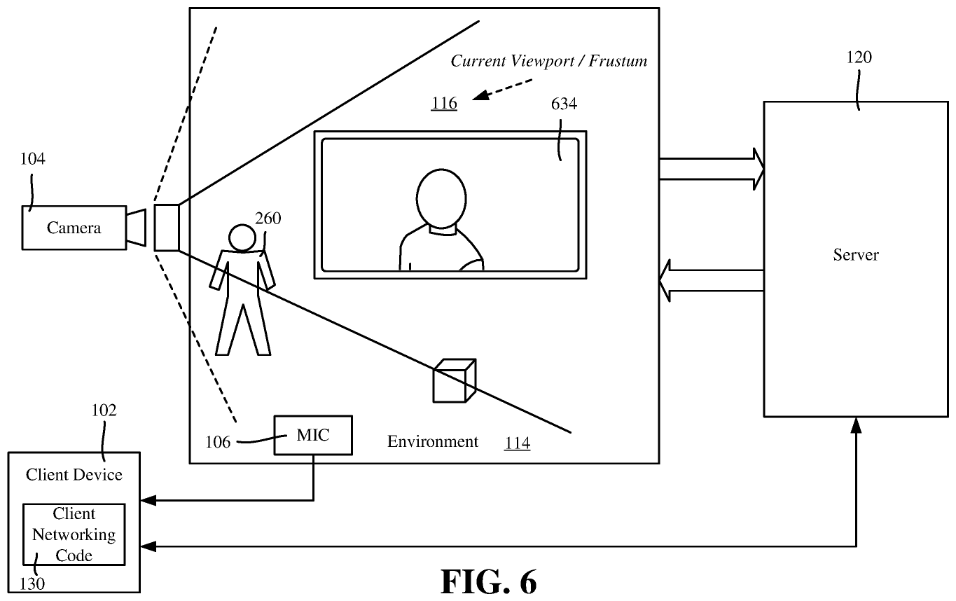

In the example scenario of FIG. 6, the camera 104 has a current viewport 116 that includes a video screen 634 with a large true pixel size. In this scenario, the client networking code 130 determines that a high resolution version is appropriate, e.g., the screen is at a close distance/is large/is zoomed in. As before, the client networking code 130 requests the video screen 634 have its video streamed at high resolution (if not already being streamed at the high resolution).

FIGS. 7-9 are directed to example operations of the stream optimization logic of the client networking code 130, for managing video streams within 3D virtual environments. As will be understood, the stream optimization logic of FIGS. 7-9 encompasses the dynamic control of downloads based on the user's camera viewport, and the real-time adjustment of stream resolution. These concepts facilitate bandwidth conservation, by more efficiently utilizing available bandwidth resources, including via the selective halting of the download of out-of-view video streams while maintaining audio playback, and dynamically adjusting resolution as appropriate for in-view video streams, contributing to overall bandwidth conservation.

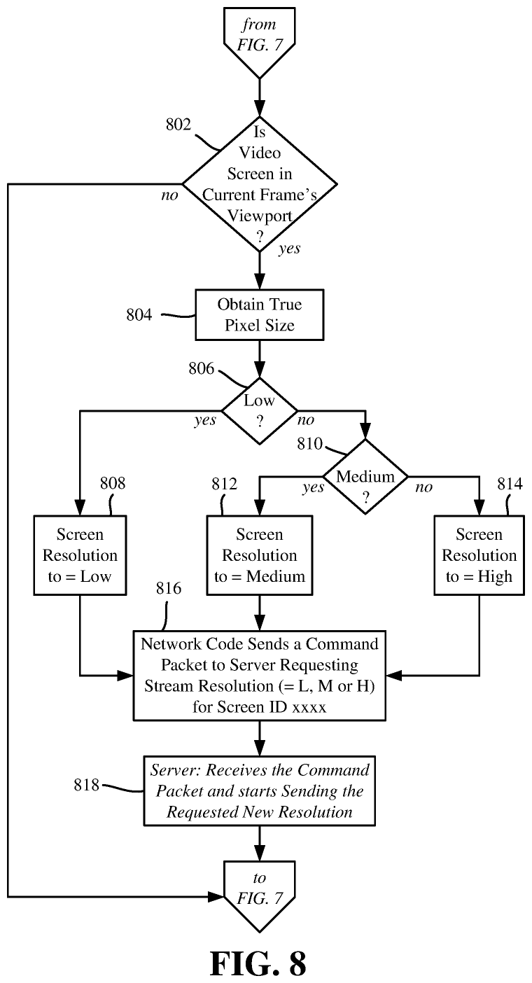

In one example implementation, the operations of FIGS. 7, 8 and/or 9 are repeated for every frame, e.g., approximately 114 times per second. Via FIG. 7, the operations are performed for each video screen for which the server downloads audiovisual data; each video screen and its corresponding video stream has an associated screen ID, which is known to the server 120 and the client networking code 130. The operations of FIG. 7 need not be run if there is no video screen ID currently known with respect to potential rendering, unless and until one or more become active.

Assuming at least one active video screen is known in the 3D environment, operation 702 of FIG. 7 represents obtaining the screen data captured in the current frame's viewport, and operation 704 represents obtaining the screen data captured in the previous frame's viewport, e.g., maintained in memory. Operation 706 selects the first active video screen, e.g., based on the presence of its ID.

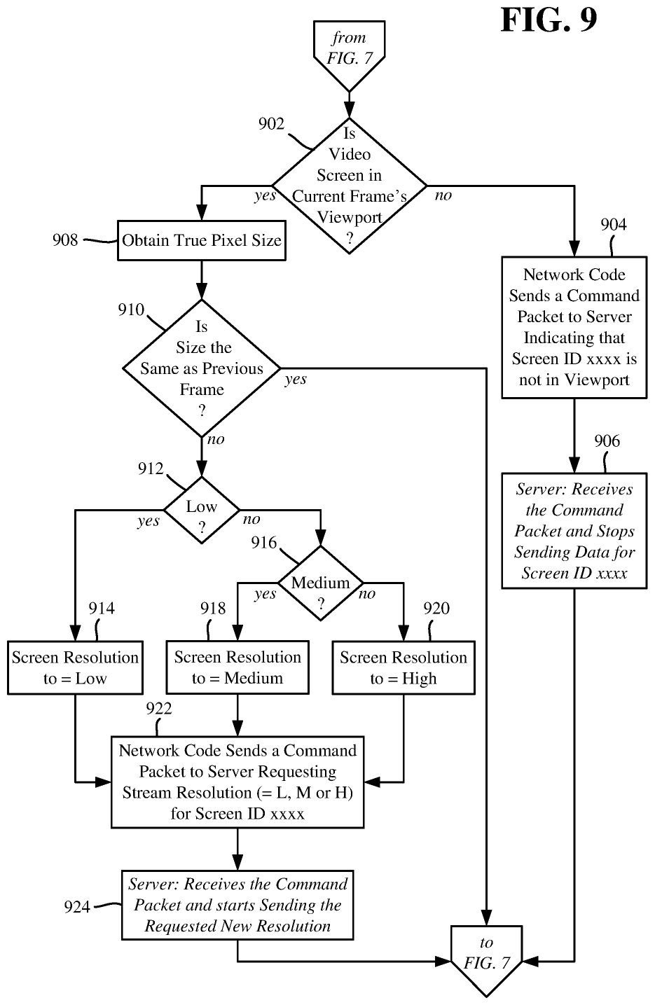

Operation 708 evaluates, based on the screen's previous frame data obtained at operation 704, whether the video screen was in the viewport of the previous frame. If so, operation 708 branches to FIG. 8, operation 802 to handle this video screen scenario. Otherwise, the video screen is new, at least with respect to the current frame, whereby operation 708 branches to FIG. 9, operation 902. Operations 710 and 712 repeat the evaluation of operation 708 for each other video screen ID, until none remain to be processed with respect to the current frame. Note that processing as described herein can occur in parallel, at least to some extent/at least in part, whereby operation 710 may not, for example, have to wait until the example operations of FIG. 8 or FIG. 9 complete before selecting a next video screen for processing, and so on.

If the video screen was not in the viewport of the previous frame, operation 802 of FIG. 8 evaluates, based on the screen's current frame data obtained at operation 702, whether the video screen is now in the current frame's viewport. For example, a frustum culling algorithm that uses bounding volumes (spheres/rectangles around items) can be used to check whether a video screen intersects or is contained within the viewport's current viewing pyramid. In one implementation, if any part of a video screen is within the viewport, the screen is treated with respect to downloading its video content as if the entire screen is visible, thereby downloading its entire video data for rendering, even if only part of that video data is rendered as visible. In other implementations, it is feasible to have a threshold level; for example, a threshold may be set such that if only five percent of a video screen is visible in the frustum, then do not download its content and/or show frozen content, or show no content at all. It is also feasible to update such a partially visible video screen's content at a lower rate, e.g., download video content once every ten frames instead of every frame.

If at operation 802 the video screen (which was not visible in the previous frame) is also not visible in the current frame, nothing needs to be done, and the process returns to FIG. 7. If instead the video screen is now in the current frame's viewport, then the server 120 needs to be instructed via a request to start streaming the video screen's video content. In one implementation, this request is incorporated into a video resolution request in that the server 120 knows to start streaming the video if the client requests a resolution for the video. Thus, the remaining operations of FIG. 8 are generally directed to resolution selection, in which the stream optimization logic operates to determine and request the resolution of a video stream, which can be based on the viewer's/camera's perceived proximity to the screen display corresponding to the screen ID within the 3D environment.

To this end, operation 804 obtains the true pixel size by analyzing the camera data 110 (FIG. 1), which can be mapped to low, medium or high resolutions via operations 806 and 808 (low), operations 810 and 812 (medium) or operation 814 (high). Once the resolution version is known, operation 816 sends (from the client network code 130) a command packet to the server requesting the desired screen resolution version, e.g., for this screen's ID (e.g., the actual ID is used, as represented by xxxx); note that this request also starts or resumes the streaming, which had been halted, as the server will return the video stream data at the requested resolution and subscribe the client device to it. Operation 818 represents the server acting on the command packet request, and the server thereafter starts downloading the video data at the requested new video resolution for this identified video screen. The process for this video screen is then finished until the next evaluation, e.g., for the next rendering frame.

Returning to operation 708 of FIG. 7, if a video screen instead was in the previous frame, operation 902 of FIG. 9 is performed. Operation 902 evaluates whether the video screen is not in the current frame, that is, the video screen was visible in the previous frame, but is no longer visible in the current frame. In this situation, operation 902 branches to operation 904, where the network code 130 (FIG. 1) sends a command packet to the server 120 indicating that the video screen having the ID xxxx (e.g., the actual ID is used, as represented by xxxx) is not in the current viewport, whereby the server 120 (its selective forwarding unit 126) acts on the command packet and stops sending data for the screen with ID xxxx.

If instead, as evaluated by operation 708 of FIG. 7 and operation 902 of FIG. 9 the video screen was visible in both the previous frame's and the current frame's viewport, whether the resolution should be adjusted is next considered, to facilitate a more optimal balance between visual quality and bandwidth efficiency.

Thus, operation 908 obtains the true pixel size, via the camera data 110, which can be based on perceived proximity from the camera to the video screen. If, as evaluated at operation 910 the true pixel size is the same as the previous frame's size, which is tracked by the client networking code 130, then no change is needed to the resolution and the process ends for this video screen.

Otherwise, in this example, the true pixel size is mapped to low, medium or high resolutions via operations 912 and 914 (low), operations 916 and 918 (medium) or operation 920 (high). Once the resolution version is known, operation 922 sends (from the client network code 130) a command packet to the server requesting the desired screen resolution version for this screen with ID of xxxx. Operation 924 represents the server acting on the command packet request, which thereafter continues downloading the video data, but at the requested new video resolution for this identified video screen. The process for this video screen is then finished until the next rendering frame. Note that operations 912-924 of FIG. 9 are generally similar to operations 804-818 of FIG. 8. Further note that the client networking code 130 can track the previous frame's resolution, and if prior to operation 922 the resolution is the same as in the previous frame even though the true pixel size has changed, the client networking code 130 can bypass sending the command at operation 922 because no resolution change is needed.

The technology described herein can be implemented in a system, a (e.g., computer-implemented) method, and/or computer-readable medium, arranged for optimizing audiovisual streams in a 3D virtual environment. The system can include a processing unit and/or memory/storage media that stores instructions configured to perform operations in the system of claims 1-10, execute the method of claims 11-15, and/or perform the operations of claims 16-20. One or more of the processors can be a graphical processing unit (GPU), which facilitates the dynamic rendering of video streams within a 3D environment. The system, method or computer-readable medium can operate to intelligently halt the download of out-of-view video streams based on the user's camera view within a 3D space. This can occur while continuously transmitting and playing the audio component of the halted video stream.

Further aspects of the system, method, and/or computer-readable medium can be directed to dynamically adjusting the resolution of video streams in real-time, based on the proximity of the camera (e.g., viewer) to the display within the 3D environment, including through a selective forwarding unit on a server, to strike a balance between visual quality and bandwidth efficiency. The technology described herein can be implemented in part (but is not limited to) using a web graphics API such as WebGPU, for enhanced graphics and compute capabilities in web browsers. The technology can be based on code/logic for selectively halting the download of out-of-view video streams based on the user's camera view within the 3D space, dynamically adjusting the resolution of video streams based on the proximity of the viewer to the display within the 3D environment through the selective forwarding unit on the server, and/or continuously transmitting and playing the audio component of the halted video stream through the selective forwarding unit on the server to maintain a seamless auditory experience for the user.

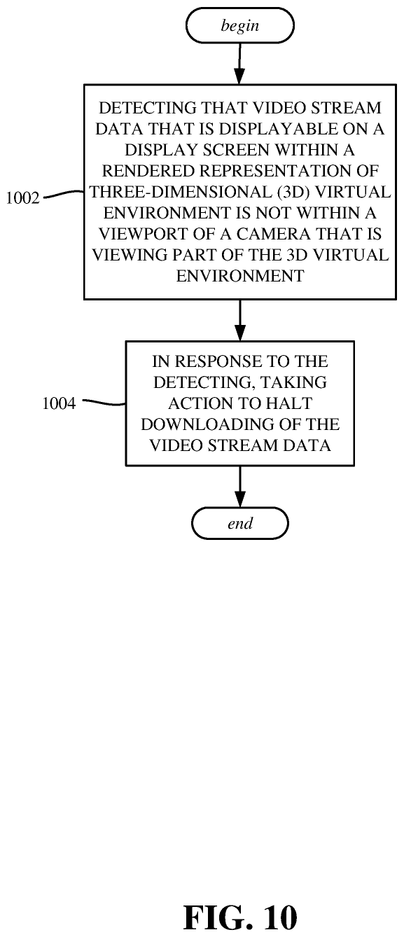

One or more aspects described herein can be embodied in a system, such as represented in the example operations of FIG. 10, and for example can include a memory that stores computer executable components and/or operations, and at least one processor that executes computer executable components and/or operations stored in the memory. Example operations of FIG. 10 can include operation 1002, which represents detecting that video stream data that is displayable on a display screen within a rendered representation of three-dimensional (3D) virtual environment is not within a viewport of a camera that is viewing part of the 3D virtual environment. Example operation 1004 represents, in response to the detecting, taking action to halt downloading of the video stream data.

Taking the action to halt the downloading of the video stream data can include communicating a request to a server.

Taking the action to halt the downloading of the video stream data can result in halted video stream data, and further operations can include receiving downloaded audio stream data that is associated with the halted video stream data, and playing the audio stream data associated with the halted video stream data.

Further operations can include detecting that the display screen is currently within the viewport, and in response to the detecting that the display screen is currently within the viewport, taking action to resume downloading of the video stream data. Further operations can include rendering the video stream data, via a graphics processing unit, as texture data in the rendered representation of the 3D virtual environment.

Taking the action to resume the downloading of the video stream data can result in downloading resumed video stream data, and further operations can include adjusting the resolution of the resumed video stream data based on perceived proximity of the camera to the display screen within the 3D environment. Further operations can include taking further action to readjust the resolution of the resumed video stream data based on a change in the perceived proximity of the camera to the display screen within the 3D environment.

Further operations can include evaluating the viewport of the camera to determine whether the display screen has changed from not being within the viewport of the camera to being currently within the viewport of the camera, and in response to the detecting that the display screen is currently within the viewport of the camera, determining a selected resolution based on perceived proximity of the camera to the display screen, and taking action to resume downloading of the video stream data at the selected resolution. Evaluating the viewport of the camera can occur at a rate of once per rendering frame.

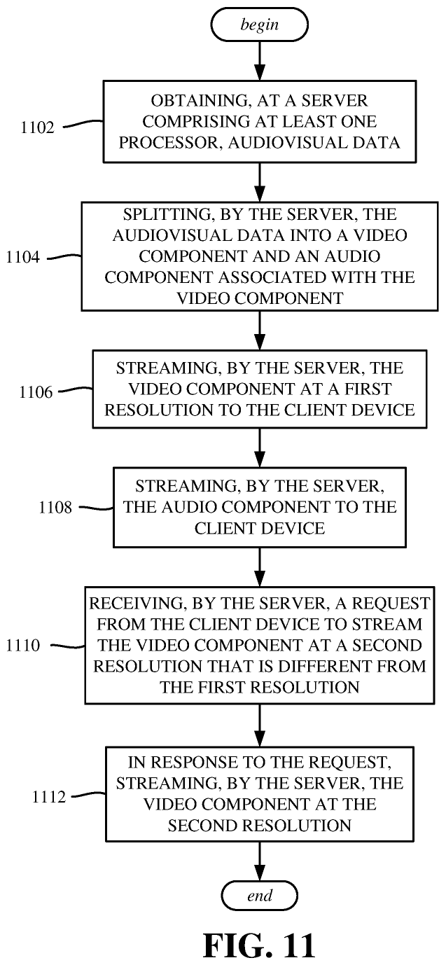

One or more example implementations and embodiments, such as corresponding to example operations of a method, are represented in FIG. 11.

Example operation 1102 represents obtaining, at a server comprising at least one processor, audiovisual data. Example operation 1104 represents splitting, by the server, the audiovisual data into a video component and an audio component associated with the video component. Example operation 1106 represents streaming, by the server, the video component at a first resolution to the client device. Example operation 1108 represents streaming, by the server, the audio component to the client device. Example operation 1110 represents receiving, by the server, a request from the client device to stream the video component at a second resolution that is different from the first resolution. Example operation 1112 represents, in response to the request, streaming, by the server, the video component at the second resolution.

The request can be a first request from the client device, and further operations can include receiving, by the server, a second request from the client device to stream the video component at a third resolution that is different from the second resolution, and in response to the second request, streaming, by the server, the video component at the third resolution.

The request can be a first request from the client device, and further operations can include receiving, by the server, a second request from the client device to halt the streaming of the video component, and in response to the request, halting the streaming of the video component to the client device, and continuing the streaming of the audio component to the client device.

The video component can be a first video component that is halted, the audio component can be a first audio component that continues to be streamed, and further operations can include streaming, by the server, a second video component to the client device, and streaming, by the server, a second audio component to the client device, while the first video component is halted and the first audio component continues to be streamed.

further operations can include receiving, by the server, a third request from the client device to resume the streaming of the video component, and in response to the request, resuming the streaming of the video component to the client device. The third request from the client device can be associated with a request to stream the video component at a third resolution, and resuming of the streaming of the video component to the client device can include streaming the video component at the third resolution.

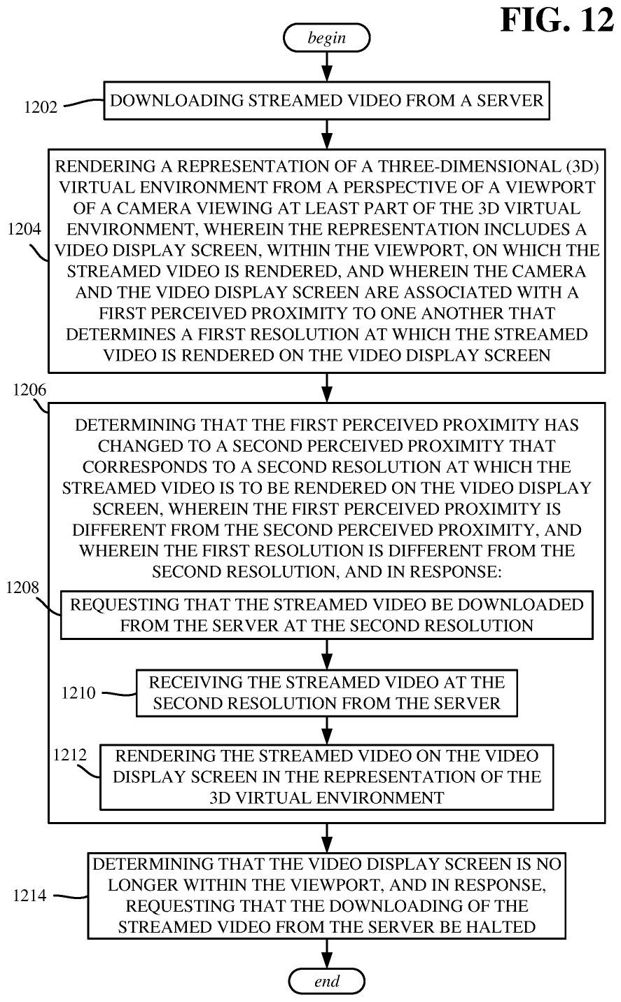

FIG. 12 summarizes various example operations, e.g., corresponding to a machine-readable medium, comprising executable instructions that, when executed by at least one processor, facilitate performance of operations. Example operation 1202 represents downloading streamed video from a server. Example operation 1204 represents rendering a representation of a three-dimensional (3D) virtual environment from a perspective of a viewport of a camera viewing at least part of the 3D virtual environment, wherein the representation includes a (virtual) video display screen, within the viewport, on which the streamed video is rendered, and wherein the camera and the video display screen are associated with a first perceived proximity to one another that determines a first resolution at which the streamed video is rendered on the video display screen. Example operation 1206 represents determining that the first perceived proximity has changed to a second perceived proximity that corresponds to a second resolution at which the streamed video is to be rendered on the video display screen, wherein the first perceived proximity is different from the second perceived proximity, and wherein the first resolution is different from the second resolution, and in response, performing operations 1208, 1210 and 1212. Example operation 1208 represents requesting that the streamed video be downloaded from the server at the second resolution. Example operation 1210 represents receiving the streamed video at the second resolution from the server. Example operation 1212 represents rendering the streamed video on the video display screen in the representation of the 3D virtual environment. Example operation 1214 represents determining that the video display screen is no longer within the viewport, and in response, requesting that the downloading of the streamed video from the server be halted.

Further operations can include downloading streamed audio, associated with the streamed video, from the server, and outputting the streamed audio independent of whether the downloading of the streamed video is ongoing or has been halted.

Further operations can include, after the downloading of the streamed video has been halted, determining that the video display screen is again within the viewport, and in response, requesting that the downloading of the streamed video from the server be resumed. Further operations can include, after the downloading of the streamed video has been halted, determining that the video display screen is again within the viewport, determining a third perceived proximity of the camera to the video display screen that corresponds to a third resolution at which the streamed video is to be rendered on the video display screen, wherein the third resolution comprises one of: the first resolution, the second resolution, or a different resolution from the first resolution and the second resolution, and requesting that the streamed video from the server be downloaded at the third resolution.

Further operations can include, after the downloading of the streamed video has been halted, determining that the video display screen is again within the viewport, determining a third perceived proximity of the camera to the video display screen that corresponds to a third resolution at which the streamed video is to be rendered on the video display screen, wherein the third resolution comprises one of: the first resolution, the second resolution, or a different resolution from the first resolution and the second resolution, and requesting that the downloading of the streamed video from the server be resumed at the third resolution.

As can be seen, the technology described herein facilitates efficiently managing bandwidth in a way that maintains a desirable user experience in 3D virtual environments, by intelligently managing the streaming process, ensuring a balance between resource utilization, cost-effectiveness, and an enhanced user experience within dynamic, web-connected 3D spaces. This can include dynamically controlling the download of video streams based on their relevance to the user's immediate visual context, which enhances bandwidth efficiency, reduces unnecessary data transmission, and contributes to an overall improvement in the user experience within 3D virtual environments. Selectively stopping out-of-view streams is accomplished, while being able to maintain audio associated with those streams. The technology described herein also can improve visual quality by dynamically adapting stream resolution based on the user's viewing perspective/proximity to rendered video display screen representations.

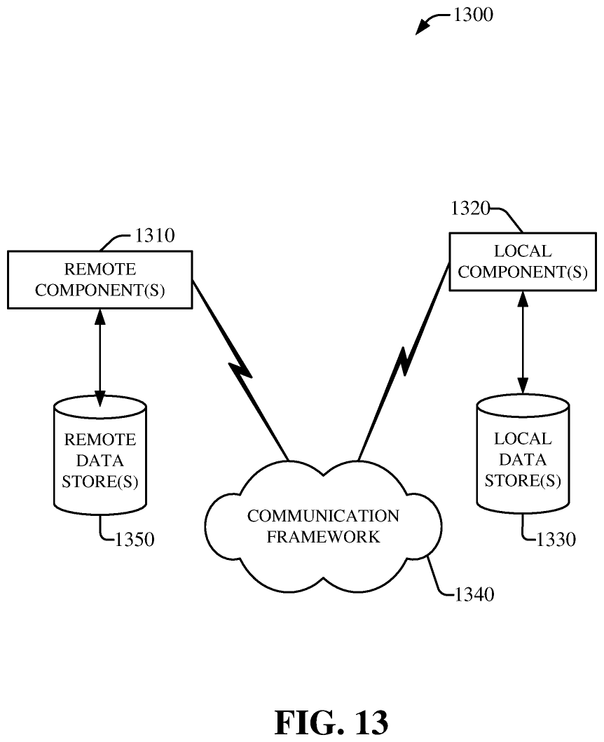

FIG. 13 is a schematic block diagram of a computing environment 1300 with which the disclosed subject matter can interact. The system 1300 comprises one or more remote component(s) 1310. The remote component(s) 1310 can be hardware and/or software (e.g., threads, processes, computing devices). In some embodiments, remote component(s) 1310 can be a distributed computer system, connected to a local automatic scaling component and/or programs that use the resources of a distributed computer system, via communication framework 1340. Communication framework 1340 can comprise wired network devices, wireless network devices, mobile devices, wearable devices, radio access network devices, gateway devices, femtocell devices, servers, etc.

The system 1300 also comprises one or more local component(s) 1320. The local component(s) 1320 can be hardware and/or software (e.g., threads, processes, computing devices). In some embodiments, local component(s) 1320 can comprise an automatic scaling component and/or programs that communicate/use the remote resources 1310, etc., connected to a remotely located distributed computing system via communication framework 1340.

One possible communication between a remote component(s) 1310 and a local component(s) 1320 can be in the form of a data packet adapted to be transmitted between two or more computer processes. Another possible communication between a remote component(s) 1310 and a local component(s) 1320 can be in the form of circuit-switched data adapted to be transmitted between two or more computer processes in radio time slots. The system 1300 comprises a communication framework 1340 that can be employed to facilitate communications between the remote component(s) 1310 and the local component(s) 1320, and can comprise an air interface, e.g., Uu interface of a UMTS network, via a long-term evolution (LTE) network, etc. Remote component(s) 1310 can be operably connected to one or more remote data store(s) 1350, such as a hard drive, solid state drive, SIM card, device memory, etc., that can be employed to store information on the remote component(s) 1310 side of communication framework 1340. Similarly, local component(s) 1320 can be operably connected to one or more local data store(s) 1330, that can be employed to store information on the local component(s) 1320 side of communication framework 1340.

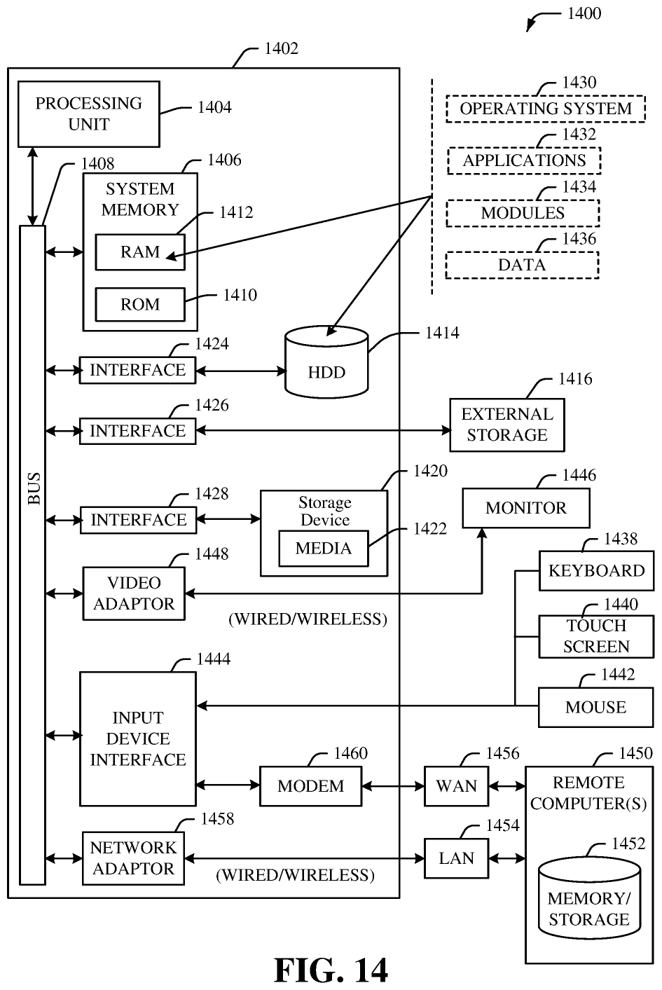

In order to provide additional context for various embodiments described herein, FIG. 14 and the following discussion are intended to provide a brief, general description of a suitable computing environment 1400 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), and can include one or more external storage devices 1416 (e.g., a magnetic floppy disk drive (FDD) 1416, a memory stick or flash drive reader, a memory card reader, etc.). While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414.

Other internal or external storage can include at least one other storage device 1420 with storage media 1422 (e.g., a solid state storage device, a nonvolatile memory device, and/or an optical disk drive that can read or write from removable media such as a CD-ROM disc, a DVD, a BD, etc.). The external storage 1416 can be facilitated by a network virtual machine. The HDD 1414, external storage device(s) 1416 and storage device (e.g., drive) 1420 can be connected to the system bus 1408 by an HDD interface 1424, an external storage interface 1426 and a drive interface 1428, respectively.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (virtual machine) of multiple virtual machines hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1494 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are examples and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a processor; and
a memory that stores executable instructions that, when executed by the processor, facilitate performance of operations, the operations comprising:
detecting that video stream data that is displayable on a display screen within a rendered representation of three-dimensional (3D) virtual environment is not within a viewport of a camera that is viewing part of the 3D virtual environment; and
in response to the detecting, taking action to halt downloading of the video stream data.

2. The system of claim 1, wherein the taking of the action to halt the downloading of the video stream data comprises communicating a request to a server.

3. The system of claim 1, wherein the taking of the action to halt the downloading of the video stream data results in halted video stream data, and wherein the operations further comprise receiving downloaded audio stream data that is associated with the halted video stream data, and playing the audio stream data associated with the halted video stream data.

4. The system of claim 1, wherein the operations further comprise detecting that the display screen is currently within the viewport, and in response to the detecting that the display screen is currently within the viewport, taking action to resume downloading of the video stream data.

5. The system of claim 4, wherein the operations further comprise rendering the video stream data, via a graphics processing unit, as texture data in the rendered representation of the 3D virtual environment.

6. The system of claim 4, wherein the taking of the action to resume the downloading of the video stream data results in downloading resumed video stream data, and wherein the operations further comprise adjusting the resolution of the resumed video stream data based on perceived proximity of the camera to the display screen within the 3D environment.

7. The system of claim 6, wherein the operations further comprise taking further action to readjust the resolution of the resumed video stream data based on a change in the perceived proximity of the camera to the display screen within the 3D environment.

8. The system of claim 1, wherein the operations further comprise evaluating the viewport of the camera to determine whether the display screen has changed from not being within the viewport of the camera to being currently within the viewport of the camera, and in response to the detecting that the display screen is currently within the viewport of the camera, determining a selected resolution based on perceived proximity of the camera to the display screen, and taking action to resume downloading of the video stream data at the selected resolution.

9. The system of claim 8, wherein the evaluating of the viewport of the camera occurs at a rate of once per rendering frame.

10. A method, comprising:
obtaining, at a server comprising at least one processor, audiovisual data;
splitting, by the server, the audiovisual data into a video component and an audio component associated with the video component;
streaming, by the server, the video component at a first resolution to the client device;
streaming, by the server, the audio component to the client device;
receiving, by the server, a request from the client device to stream the video component at a second resolution that is different from the first resolution; and
in response to the request, streaming, by the server, the video component at the second resolution.

11. The method of claim 10, wherein the request is a first request from the client device, and further comprising receiving, by the server, a second request from the client device to stream the video component at a third resolution that is different from the second resolution, and in response to the second request, streaming, by the server, the video component at the third resolution.

12. The method of claim 10, wherein the request is a first request from the client device, and further comprising receiving, by the server, a second request from the client device to halt the streaming of the video component, and in response to the request, halting the streaming of the video component to the client device, and continuing the streaming of the audio component to the client device.

13. The method of claim 12, wherein the video component comprises a first video component that is halted, wherein the audio component comprises a first audio component that continues to be streamed, and further comprising streaming, by the server, a second video component to the client device, and streaming, by the server, a second audio component to the client device, while the first video component is halted and the first audio component continues to be streamed.

14. The method of claim 12, further comprising receiving, by the server, a third request from the client device to resume the streaming of the video component, and in response to the request, resuming the streaming of the video component to the client device.

15. The method of claim 14, wherein the third request from the client device is associated with a request to stream the video component at a third resolution, and wherein the resuming of the streaming of the video component to the client device comprises streaming the video component at the third resolution.

16. A non-transitory machine-readable medium, comprising executable instructions that, when executed by at least one processor, facilitate performance of operations, the operations comprising:
downloading streamed video from a server;
rendering a representation of a three-dimensional (3D) virtual environment from a perspective of a viewport of a camera viewing at least part of the 3D virtual environment, wherein the representation includes a video display screen, within the viewport, on which the streamed video is rendered, and wherein the camera and the video display screen are associated with a first perceived proximity to one another that determines a first resolution at which the streamed video is rendered on the video display screen;
determining that the first perceived proximity has changed to a second perceived proximity that corresponds to a second resolution at which the streamed video is to be rendered on the video display screen, wherein the first perceived proximity is different from the second perceived proximity, and wherein the first resolution is different from the second resolution, and in response:
requesting that the streamed video be downloaded from the server at the second resolution;
receiving the streamed video at the second resolution from the server; and
rendering the streamed video on the video display screen in the representation of the 3D virtual environment; and
determining that the video display screen is no longer within the viewport, and in response, requesting that the downloading of the streamed video from the server be halted.

17. The non-transitory machine-readable medium of claim 16, wherein the operations further comprise downloading streamed audio, associated with the streamed video, from the server, and outputting the streamed audio independent of whether the downloading of the streamed video is ongoing or has been halted.

18. The non-transitory machine-readable medium of claim 16, wherein the operations further comprise, after the downloading of the streamed video has been halted, determining that the video display screen is again within the viewport, and in response, requesting that the downloading of the streamed video from the server be resumed.

19. The non-transitory machine-readable medium of claim 18, wherein the operations further comprise, after the downloading of the streamed video has been halted, determining that the video display screen is again within the viewport, determining a third perceived proximity of the camera to the video display screen that corresponds to a third resolution at which the streamed video is to be rendered on the video display screen, wherein the third resolution comprises one of: the first resolution, the second resolution, or a different resolution from the first resolution and the second resolution, and requesting that the streamed video from the server be downloaded at the third resolution.

20. The non-transitory machine-readable medium of claim 16, wherein the operations further comprise, after the downloading of the streamed video has been halted, determining that the video display screen is again within the viewport, determining a third perceived proximity of the camera to the video display screen that corresponds to a third resolution at which the streamed video is to be rendered on the video display screen, wherein the third resolution comprises one of: the first resolution, the second resolution, or a different resolution from the first resolution and the second resolution, and requesting that the downloading of the streamed video from the server be resumed at the third resolution.
